(19) United States
(12) Patent Application Publication
(10) Pub. No.: US 2024/0378625 A1
(43) Pub. Date: Nov. 14, 2024

(54) SYSTEM AND METHOD FOR SELF-TEST AUTONOMOUS AUTHENTICATION AND FOR INTERPERSONAL INNOCUITY ACKNOWLEDGEMENT

(71) Applicants: Sebastien HARVEY, Chicoutimi (CA); Mario PERRON, Saint-Colomban (CA)

(72) Inventors: Sebastien HARVEY, Chicoutimi (CA); Mario PERRON, Saint-Colomban (CA)

(21) Appl. No.: 18/662,640

(22) Filed: May 13, 2024

Related U.S. Application Data
(60) Provisional application No. 63/465,618, filed on May 11, 2023.

(51) Int. Cl. G06Q 30/018

(52) U.S. Cl. CPC G06Q 30/018

(57) ABSTRACT

A method for verifying the innocuity of participants in biosecure environments using a system comprising a tested participant device, a verifier device, and a test results server. The method involves receiving identification data, continuously, and test results simultaneously, ensuring consistency and integrity through continuous verification. By continuously monitoring the execution of a test for a specific pathogen, while verifying the user identity concurrently, the integrity of the test and its association to the person is ensured. The verifier device may verify the validation of integrity based on the received test data, providing real-time confirmation of participant innocuity, and display the validation to any manager of an event. By integrating peer-to-peer verification, the method ensures reliable access control and pathogen testing compliance.

### RELATED APPLICATION

The present patent application claims priority to, or benefit from, U.S. provisional Patent Application No. 63/465,618, filed May 11, 2023, which is incorporated herein by reference in its entirety.

### TECHNICAL FIELD

The present invention relates to the field of technological validation of the integrity of sanitary testing.

### BACKGROUND

The COVID-19 pandemic has highlighted the risk factors of rapid and international spread of pathogens, impacting all sectors of activity and the lives of billions of people. But the pandemic is in fact an epiphenomenon of a larger context, in which there are many pathogens which may be able to impact in a comparable or even greater way the health of people and the different sectors of activity of a society.

It is consequently necessary to design systemic responses to these risks, as the number of existing pathogens makes it virtually ineffective to implement sanitary defense strategies specific to a single pathogen. It is therefore important to develop systems and methods that facilitate the implementation of global biomonitoring processes.

This reality highlights the need to move from a pandemic to an endemic phase in our relationship with the spread of new pathogens. There is a need to operationalize biosecure spaces by proposing biosecurity systems and methods in order to be part of a global biosurveillance logic.

In order to reactivate the activities of the different economic sectors and to allow a recovery of the social dynamics, it is necessary to use all the resources in place, to conceive new ones and to optimize their assembly.

Existing tests that confirm or deny the innocuity of a participant with respect to one or more pathogens need to be integrated with a whole ecosystem of information. This biomonitoring ecosystem must be operationalized in a real context, in real time, in order to offer a continuous verification of the safety of participants throughout a given period in a given location or in motion.

Historically, the participants of an event or the people frequenting a place have always entrusted, in a sanitary context, the responsibility of controlling the safety of other people to a third party. Confidence in the reliability of a process, its method and the real-time management of results has always been in the hands of authorities outside the participants themselves.

### SUMMARY

The present disclosure provides systems and methods for managing biosecure spaces and allowing a plurality of participants to verify the safety of each with respect to one or more pathogens.

More precisely, according to an embodiment, the system and method described herein allows to communicate to the participants the rules to follow and the actions to complete before arriving in the biosecure space, to manage their arrival on site, to test them for one or more pathogens, to communicate the result of the test to them, to provide them with a proof of result, to manage their rights of entry to the place or participation in the event and finally, to allow the participants to check the test results of the participants around them.

In this context, biosecure spaces can be a location, an event, an activity, groups of people gathered in a place or on the move, a vehicle, or any other device for movement or transportation.

According to another embodiment, the new possibilities offered by digital technology allow to envision new possibilities for the distribution of roles in collective sanitary safety, involving the participants themselves at the heart of the process of verifying the safety of stakeholders in a given place at a given time, thus creating a distribution of powers to verify the results of recognized and authorized medical tests.

The purpose of this transformation is to ensure that continuously, in a given place, at a given time, the participants are not contagious and that they have been tested for the period concerned or for the duration of the event, and that the result of this test can be trusted to be both a valid result (i.e., the actual result of an approved test correctly performed) and also trusted to be associated to the right person.

Test results need to be verifiable by the participants themselves, among themselves, or by the employees responsible for the event or the area, in real time. It is by developing new systems and methods, that an effective and deployable biosurveillance system by operators of biosecure spaces may be made possible.

Embodiments of the present disclosure generally provide a system and method of interactive technologies that allow a plurality of participants to acknowledge each other's innocuity about one or more pathogens.

These systems and methods allow participants to be tested for one or more specific pathogens onsite or prior to arrival, depending on the parameters of the biosecure space operator, and then provide the result to each participant, in addition to allowing them to verify in real time that the participants around them have been tested and are not infected with a specific pathogen for the specified time period.

The validity period of the test results is defined by the operator of the biosecure space. The test/result/verification cycle is repeated at each period determined by the operator of the biosecure space (number of hours, number of days).

According to an aspect of the disclosure, there is provided a method for verifying innocuity of a tested participant associated to a tested participant device, the method to be executed by a system comprising the tested participant device, a test results server, and a verification server, the method comprising:
receiving, by the verification server, identification data from the tested participant device;
receiving, by the verification server or the test results server, test data simultaneously with the identification data to determine that the test data is consistent with the identification data of the tested participant device and the pathogen testing system, further comprising:
continuously verifying, by the participant device, an integrity of the test data during a period of testing and receiving of the test data; and
continuously verifying consistency of the identification data received from the tested participant device, by the verification server or the test results server;
recording, at the test results server, the test data result and associating with the test data result a validation of identification based on the identification data received simultaneously with the test data and a validation of integrity based on the step of continuously verifying the integrity of test data when receiving the test data.

According to an embodiment, the verification server is a verifier device, the verifier device being a portable electronic device configured to communicate with the test results server, participant device.

According to an embodiment, the identification data comprises a participant identifier, a test kit identifier, and accessory identifiers.

According to an embodiment, the test data comprises results of testing for a specific pathogen by the pathogen testing system.

According to an embodiment, the validation of integrity includes verifying the continuity and consistency of the identification data throughout the testing process.

According to an embodiment, the continuous verification of the integrity of the test data comprises monitoring the testing process through image analysis using a camera of the participant device.

According to an embodiment, the continuous verification of the integrity of the test data comprises ensuring compliance with predefined testing standards.

According to an embodiment, the validation of identification is performed using facial recognition technology to confirm the identity of the participant.

According to an embodiment, the test data result is recorded using distributed ledger technology to ensure data availability and verifiability.

According to another aspect of the disclosure, there is provided a method for verifying innocuity of a tested participant associated to a tested participant device, the method to be executed by a system comprising the tested participant device and the verifier device, and a test results server, the method comprising:
receiving, by the verifier device, identification data from the tested participant device;
receiving, by the verifier device or by the test results server and then by the verifier device, test data simultaneously with the identification data to determine that the test data is consistent with the identification data of the tested participant device, further comprising continuously verifying at least one of:
   an integrity of the test data during a period of testing and receiving of the test data and
   consistency of the identification data received from the tested participant device;
continuously displaying a validation of integrity of the tested participant on a display of the verifier device on another device for visual display of test results based on the step of continuously verifying the integrity of test data at the verifier device when receiving the test data result.

According to an embodiment, there is further provided a step of continuously verifying both: the integrity of the test data during the period of testing and receiving of the test data and consistency of the identification data received from the tested participant device.

According to an embodiment, the validation of integrity includes verifying the continuity and consistency of the identification data throughout the testing process.

According to an embodiment, there is further provided a step of providing an audible or haptic indication on the verifier device to confirm the validation of integrity of the tested participant.

According to an embodiment, there is further provided a step of opening a physical gate of access to a physical location to the tested participant.

According to an embodiment, the continuous verification of the integrity of the test data includes monitoring the testing process through image analysis using a camera of the verifier device's camera.

According to an embodiment, the continuous verification of the integrity of the test data includes ensuring compliance with predefined testing standards.

According to an embodiment, there is further provided a step of transmitting the test data result to the verifier device from the test results server via a telecommunication network.

According to an embodiment, there is further provided a step of providing a notification to the verifier device when a non-tested participant is detected within the vicinity of the tested participant.

According to an embodiment, the identification data comprises a participant device identifier and accessory identifiers.

According to an embodiment, the test data comprises results of testing for a specific pathogen.

Other technical features may be readily apparent to one skilled in the art from the following figures, descriptions and claims. The features of the present invention which are believed to be novel are set forth with particularity in the appended claims.

### BRIEF DESCRIPTION OF THE DRAWINGS

Further features and advantages of the present disclosure will become apparent from the following detailed description, taken in combination with the appended drawings, in which:

FIG. 1 is a block diagram of a system that allows an issuer to validate and record test results from participants and allow digital verification of the results by other participants, without revealing the identity of the person being tested, in accordance with at least one embodiment of the present disclosure;

FIG. 2 is a block diagram of a system that allows visual or digital verification of a participant's test result by other participants in biosecure spaces, in specific locations or on the move, in accordance with at least one embodiment of the present disclosure;

FIG. 3 is a flow diagram of a method for processing and validating data by the system of FIG. 1, in accordance with at least one embodiment of the present disclosure;

FIG. 4 is a block diagram of another system that allows an issuer to validate and record test results from participants and allow digital verification of the results by other participants, without revealing the identity of the person being tested, in accordance with at least one embodiment of the present disclosure;

FIG. 5 is a block diagram of a system that allows visual or digital verification of a participant's test result by other participants in biosecure spaces, in specific locations or on the move, in accordance with at least one embodiment of the present disclosure;

FIG. 6 is a flow diagram of a method for processing and validating data by the system of FIG. 4, in accordance with at least one embodiment of the present disclosure; and

FIG. 7 is a block diagram of a system for peer-to-peer innocuity acknowledgement, in accordance with at least one embodiment of the present disclosure.

It will be noted that throughout the appended drawings, like features are identified by like reference numerals.

### DETAILED DESCRIPTION

A novel system and method for allowing a plurality of participants to acknowledge each other's innocuity regarding one or more pathogens will be described hereinafter. Although the invention is described in terms of specific illustrative embodiment(s), it is to be understood that the embodiment(s) described herein are by way of example only and that the scope of the invention is not intended to be limited thereby.

Embodiments of the present disclosure generally provide a system of interactive technologies to allow a plurality of participants to acknowledge each other's innocuity about one or more pathogens. By way of non-limiting example, such a way of verifying the innocuity may comprise: the use of a mobile digital device, visual devices, haptic devices, wearable devices, notification processes, automated or manual scanning mechanisms.

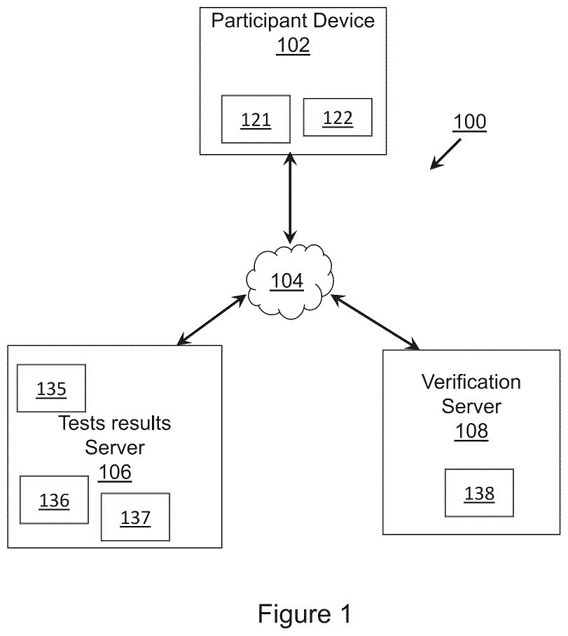

FIG. 1 depicts a simplified schematic of a representative system 100 for enabling synchronization between at least one participant device 102, the test result documentation system for validating the innocuity, also referred to as “tests results server 106” and the result verification system, also referred to as “verification server 108”. It should be understood that system 100 shown in FIG. 1 is for illustrative purposes only and that any other suitable system could be used in conjunction or in lieu of system 100 according to one embodiment of the present disclosure. The participant device 102, the test results server 106 and the verification server 108 communicate with each other via a telecommunication network 104.

The participant device 102 comprises a participant device processor 121 and a device computer-readable memory 122 for storing instructions executable at the participant device processor 121.

The test results server 106 comprises a test results server processor 135 and a results server computer-readable memory 137 for storing the instructions executable by the test results server processor 135. The verification server 108 comprises a verification processor and a verification computer-readable memory for storing instructions executable by the verification processor. The test results server 106 also has a test results database 136 and the verification server 108 has a verification database 138.

The system 100 allows an issuer to validate and record test results from participants (participant device 102) and allow digital verification of the results by other participants, without revealing the identity of the person being tested. Under certain circumstances, the participant may validate his test result himself, using his device (participant device 102 which communicates with the test results database 136), if an operator of the biosecure space allows it. The result may then be available for real-time verification to other participants. The participant device 102 may be a wearable device.

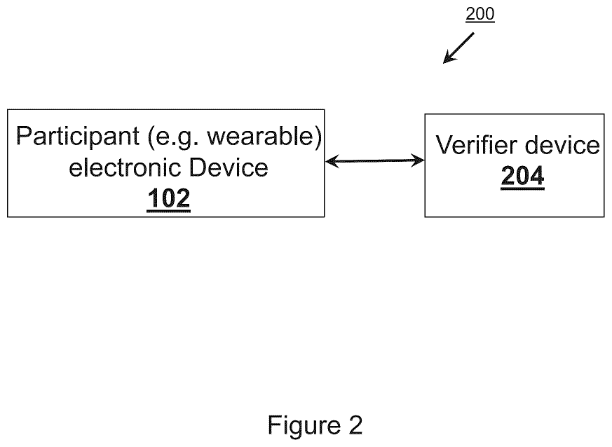

FIG. 2 is a block diagram of a system 200, in accordance with at least one embodiment, that allows visual or digital verification of a participant's test result by other participants in biosecure spaces, in specific locations or on the move. In some embodiments, a verifier 204 (also referred to herein as a verifier device 204) may communicate, via the telecommunication network 104, with the verification server 108.

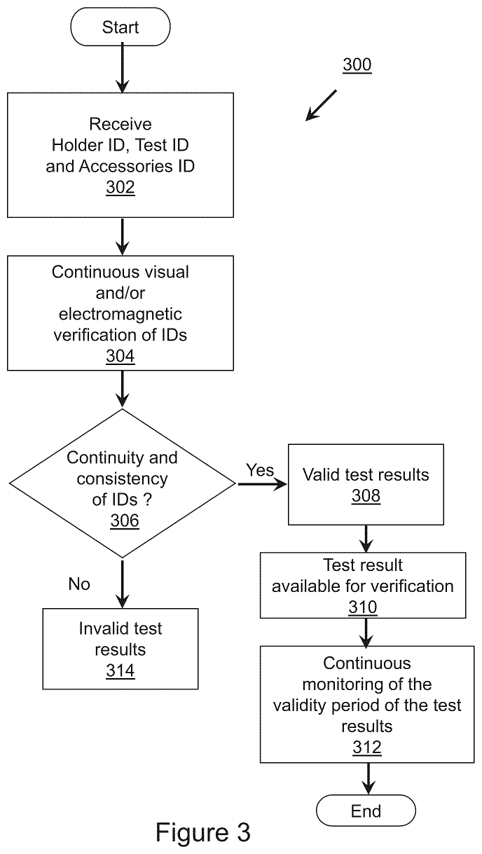

FIG. 3 is a flow diagram of a method 300, in accordance with at least one embodiment of the present disclosure. The method 300 is configured to process the input of IDs, analyze the test results, confirm the innocuity of the participant for the applicable pathogen, authorize entry, allow verification of the test results by the operator of the biosecure space and by other participants, and finally, continuously validate the test results with respect to the specified validity period.

Still referring to FIG. 3, the method 300 comprises the following steps. At step 302, a holder identification (ID), a test ID and an accessories ID (which may be collectively referred to as “identification data” or “IDs”) are received by a server. At step 304, the IDs are verified visually and/or electromagnetically. The IDs are verified continuously. For verification, the server may communicate with a database. At step 306, the server verifies continuity and consistency of IDs. At step 314, if the IDs are not continuous and consistent, then the server determines that the test results are invalid.

At step 308, if the IDs are continuous and consistent, then the test results are defined to be as valid test results. At step 310, test results are provided for verification. Further, at step 312, the server continuously monitors the validity period of the test results.

In other words, identification data are received from the participant device and test data are received simultaneous with the identification data to determine that the test data is consistent with the identification data. Additionally, there is performed a continuous verification of the integrity of identification data during a period of receiving the test data. In at least one embodiment, the identification data comprises identification of the participant device, identification of the test kit and identification of accessories.

The test result is then recorded and associated with the test result, comprising a validation of identification based on the identification data received simultaneously with the test data and a validation of integrity based on the step of continuously verifying the consistency of ID's data when receiving the test data. Consistency happens when the value remains the same over time and there are no discrepancies between each time a validation is performed.

Both the validations of identity associated to the participant and the validation of integrity of a test being performed and resulting in a test result can be performed using automated methods. For example, image analysis and facial recognition can be used to identify that the participant holding a participant device is the same person which was performing a test. This can be done by continuously filming the participant while performing the test, including auto-testing and therefore orienting the participant device's camera toward the participant being tested.

Similarly, while performing a test such as an auto-test, a camera of the participant device can be oriented toward the participant performing a test, and using image analysis, determine that all necessary steps for the integrity of the test are fully satisfied. For example, if the test implies insertion of a swab in the person nose and reinsertion of the swab in a liquid reactant, the image analysis should determine that this is actually performed (integrity of the test), while continuously determining that the person is the same person and the right person for the test (identity data), all of such determinations being made simultaneously or concurrently.

### System and Method Allowing a Participant to Autonomously Authenticate the Result of a Self-Test for One or More Pathogens.

FIGS. 1-3 illustrate a centralized verification system by a centralized authority, such as a manager of an event or venue having validation tools (e.g., a smartphone QR code reader, to name a familiar example), in accordance with at least one embodiment of the present disclosure. The centralized verification system is a participant biosurveillance system that enables the management of biosecure environments. The centralized verification system 100 is based on the use of diagnostic testing technologies, artificial intelligence, distributed ledger technologies, mobile devices and cloud computing.

A biosurveillance system 100 allows to certify the innocuity of participants concerning one or more pathogens and to make their results verifiable by different actors when required, for the required period of time, in a determined context, area or in movement.

A participant of the centralized verification system may be a human or any living being (plant, animal, bacterial culture, yeast, etc.) whose innocuity must be tested continuously or punctually in order to have access to a biosecure environment. The non-human participant can be associated with an identifiable entity (person, legal entity, autonomous or automated system, etc.) if it does not have its own identity or if it cannot technically identify itself by using the centralized verification system.

A biosecure environment may be a location, a space, an event, a group of participants, a means of transportation or displacement that is managed by a biosurveillance system for a specific period of time or continuously. The biosecure environment may be self-managed by the participants. A biosecure environment may be a combination of several biosecure environments.

The management or self-management of the biosecure environment comprises providing a process for participants to access the biosecure environment, testing participants before accessing the biosecure environment or allowing them to test themselves to verify their innocuity for one or more pathogens, validating the result of the innocuity test, record the result of the test, associate this result with the identity of the participant, provide a dashboard to the manager of the biosecure environment to control the access of the participants or a dashboard to the participants themselves if it is a self-managed biosecure environment and finally, allow the participants to verify their respective innocuity in a digital, haptic, audible or visual way.

Providing a process for participants to access the biosecure environment may involve using the biosecure environment management process, designing a custom process, or providing standardized processes that suit different categories of contexts.

Testing a participant's innocuity for one or more pathogens comprises giving the participant access to one or more diagnostic testing processes before the participant arrives at the entrance to the biosecure environment.

Validation of the safety test results may be achieved using a method through a participant-operated process using the centralized verification biosurveillance system technology. To validate the safety test results as described herein, the participant uses a device that is uniquely associated with the participant-participant device 102. The centralized verification system 100 makes it possible to link the unique identifier of a test for one or more pathogens (also referred to as a “test ID”), the identifier of the device associated with the participant (“holder ID”) and finally, the result of the test for one or more pathogens. This process may be accomplished from any location within the time frame allowed by the biosecure space.

In order to confirm that the participant associated with the device identifier is the actual test taker for one or more pathogens, a feature of the centralized verification system continuously validates, during the time required to complete the test, that the participant associated with the device identifier is the authorized test taker and remains the same participant from the beginning of the process to the end. The centralized verification system 100 continuously validates the test ID for one or more pathogens, the device ID associated with the participant, the ID for each of the accessories required to complete the test, and validates that the participant using the participant device 102 does not change during the process (in other words, verifies whether the IDs are continuous and consistent and confirms whether the IDs are valid or not). The purpose of this ID verification process is to confirm that the test result for one or more pathogens is valid, that it is associated with the correct participant, and that the testing process which ends with the generation and recording of the test result is compliant with predefined testing standards from start to finish.

The recording of the innocuity test result is performed digitally, in an automated way, in one embodiment using distributed ledger technology (blockchain), to ensure the availability and verifiability of the information in the biosafety system, by the manager of the biosecure environment, and by and within the participants. For example, the test results may be recorded by the test results server 106 at a database located therein.

A process of associating the test result with the device ID allows verification of the result by other participants and stakeholders while keeping the participant's identity secret from the verifiers, if necessary, in accordance with the concept of zero knowledge proof.

The biosecure environment dashboard allows to schedule participant entry, confirm participant innocuity, manage traceability of participant verification processes, and detect the presence of untested participants within the biosecure environment.

Each of the participants may verify the innocuity of the other participants, using the participant device 102 (which may be, for example, a digital device, which can be a wearable device), using the haptic properties of a device, or referring to a process that makes the innocuity test result of one or more participants visible.

The results of the innocuity test may be shared with the partners of the biosecure environment, if requested or if there is a pre-determined prescription to share such results, to allow the movement of participants between biosecure environments for a determined period of time or continuously, depending on the context and the biosurveillance requirements.

The centralized verification biosurveillance system 100 may use a variety of incentives, rewards, and compensation strategies to encourage participants to adhere to certain processes and best practices that enhance the security of the biosecure environment.

### System and Method Allowing a Plurality of Participants to Acknowledge Each Other's Innocuity for One or More Pathogens (Peer-to-Peer Verification).

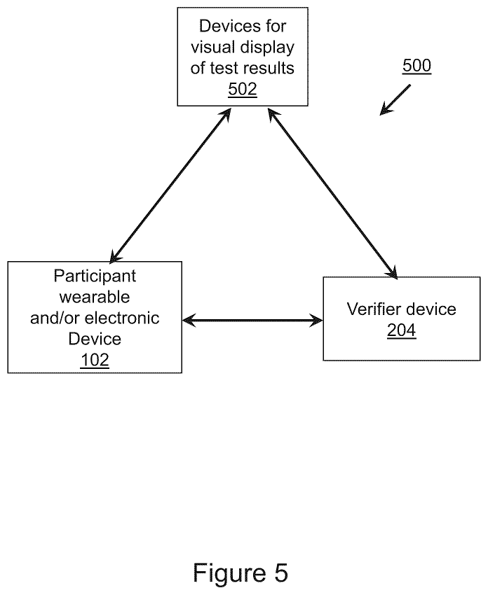

In accordance with at least one embodiment, a peer-to-peer verification is a participant biosurveillance system 500 illustrated in FIG. 5 that is configured to enable the management of biosecure environments.

The peer-to-peer verification system 500 may be configured to use diagnostic testing technologies, artificial intelligence, distributed ledgers, wearable devices and cloud computing. The biosurveillance system 500 allows to verify the innocuity of participants, between participants themselves, concerning one or more pathogens and to make their results verifiable by different actors when required, for the required period of time, in a determined context, area or in movement.

Similar to the centralized verification system, a peer-to-peer verification participant may be a person, animal, plant, or any other living thing that needs to be continuously tested for innocuity in order to gain access to a biosecure environment. As described above, a biosecure environment can be a location, a space, an event, a group of participants, a means of transportation or displacement that is managed by a biosurveillance system for a specific period of time or continuously. The biosecure environment may be a combination of several biosecure environments.

According to the method described herein, the management of the biosecure environment comprises providing a process for participants to access the biosecure environment, testing participants or allowing them to test themselves to verify their innocuity for one or more pathogens, validating the result of the innocuity test, record the result of the test, associate this result with the identity of the participant, provide a dashboard to the manager of the biosecure environment to control the access of the participants and finally, allow the participants to verify their respective innocuity in a digital, haptic, audible or visual way.

Providing a process for participants to access the biosecure environment may involve using the biosecure environment management process, designing a custom process, or providing standardized processes that suit different categories of contexts.

Testing a participant's innocuity for one or more pathogens may involve using one or more diagnostic tests at the entrance to the biosecure environment, or giving the participant access, if requested by the biosecure environment manager, to one or more diagnostic testing processes before arriving at the entrance to the biosecure environment.

Validation of the innocuity test results may be completed using multiple processes, operated by manager servers (managers) of the biosecure environment or by a third-party server, managed remotely or automated.

The recording of the innocuity test result may be completed digitally, in a manual or automated manner, to ensure the availability and verifiability of the information in the biosurveillance system, by the manager of the biosecure environment, and by and within the participants.

A process of associating the test result with the participant's identity, without disclosing it, allows verification of the result by other participants and stakeholders while keeping the participant's identity secret from the verifiers, if necessary, in accordance with the concept of zero knowledge proof.

The biosecure environment manager dashboard allows to schedule participant entry, confirm participant innocuity, manage traceability of participant verification processes, and detect the presence of untested participants within the biosecure environment.

Each of the participants can verify the innocuity of the other participants, using a digital device, wearing a device, using the haptic properties of a device, or referring to a process that makes the innocuity test result of one or more participants visible.

The results of the innocuity test can be shared with the partners of the biosecure environment, if required, to allow the movement of participants between biosecure environments for a determined period of time or continuously, depending on the context and the biosurveillance requirements.

The peer-to-peer verification biosurveillance system may use a variety of incentives, rewards, and compensation strategies to encourage participants to adhere to certain processes and best practices that enhance the security of the biosecure environment.

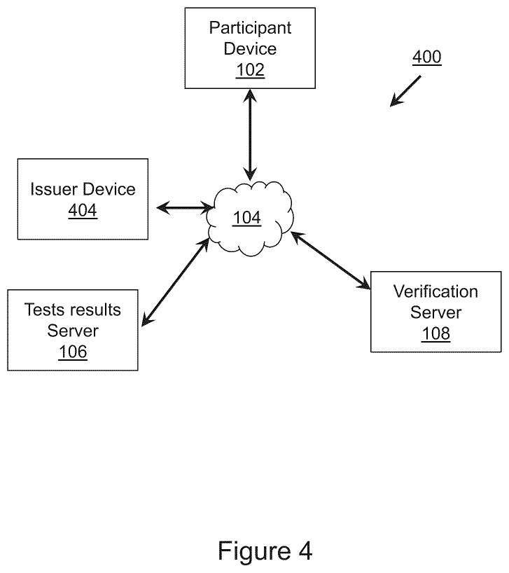

System 400, illustrated in FIG. 4, may comprise an issuer device 404, which may communicate with the participant device 102, the test results server 106 and the verification server 108 via the network 104.

FIG. 5 illustrates an embodiment of system 500 which comprises one or more devices for visual display of test results 502, participant device 102 and the verifier 204 which communicate among each other.

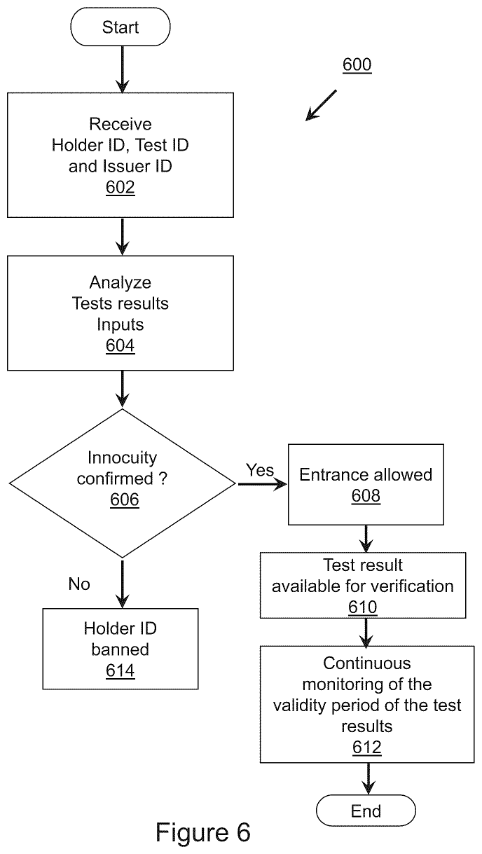

FIG. 6 illustrates the steps of the method configured to be executed by the system of FIGS. 4-5. At step 602, the system receives holder ID, test ID, and issuer ID. At step 604, the test results are analyzed. At step 606, the system determines whether the innocuity can be confirmed. If the innocuity is not confirmed at step 606, the holder ID is banned at step 614. If the innocuity is confirmed at step 606, the entrance is allowed at step 608. At step 610, test results are available for verification. According to an embodiment, at step 612, the system executes continuous monitoring of the test results during the validity period.

The system and method as described herein may allow a plurality of participants to acknowledge each other's innocuity about one or more pathogens, at a fixed location, on the move or during an event. The peer-to-peer verification system is a biosurveillance technology, based on artificial intelligence, distributed ledgers and wearable devices. A participant device of a participant wanting to access a biosecure environment, helps to validate the participant's identity. The participant may be tested for one or more specific pathogens. The participant device receives the result, and the participant is admitted or not depending on the result obtained. The participant may then verify the innocuity of the other participants or be verified by them, continuously, in real time, and be warned if a non-tested person is present in his personal biosecurity perimeter.

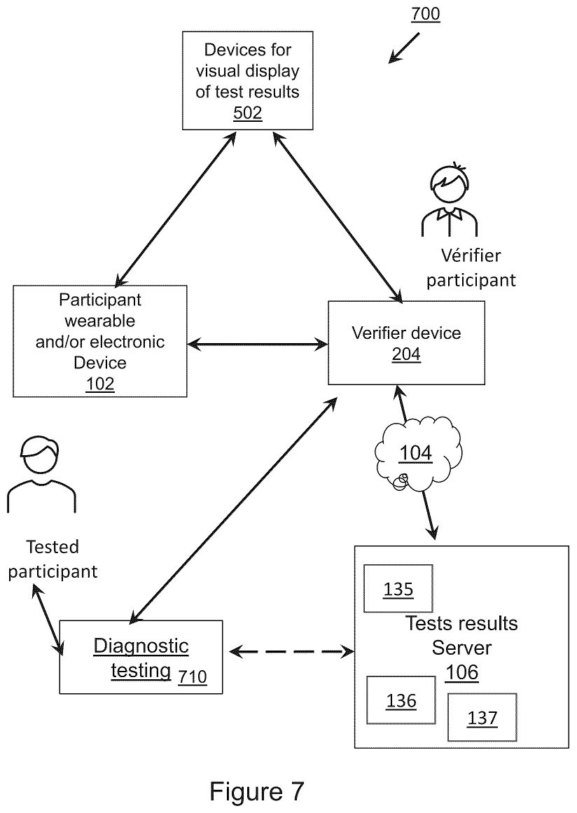

Thus, in the peer-to-peer verification of innocuity, verification is provided by the verifier device 204 of the tested participant device 102, as illustrated in FIG. 7. The tested participant device 102 (of the participant wanting to access a biosecure environment) communicates with the verifier device 204 in order to validate the ID of the tested participant device 102. The tested participant may be tested for one or more specific pathogens. For example, the results of such tests may be at the test results server 106, and the verifier device 204 may communicate, via the network 104 to verify whether the tested participant's device 102 is identified at the test results server 106. The verifier device 204 may receive the result from the test result server 106, and the tested participant is admitted or not depending on the result obtained. For this, a notification may be displayed on the devices for visual display of the test results 502, on the verifier device 204 and/or on the tested participant device 102.

The verifier device 204 (and therefore verifier participant) may then verify the innocuity of the other participants or be verified by them, continuously, in real time, and be warned if a non-tested person (participant) is present in his personal biosecurity perimeter.

In some embodiments, the issuer device 404 may provide a testing environment itself, testing the tested participant and communicate the results to the test results server 106.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for verifying innocuity of a tested participant associated to a tested participant device, the method to be executed by a system comprising the tested participant device, a test results server, and a verification server, the method comprising:
receiving, by the verification server, identification data from the tested participant device;
receiving, by the verification server or the test results server, test data simultaneously with the identification data to determine that the test data is consistent with the identification data of the tested participant device and the pathogen testing system, further comprising:
continuously verifying, by the participant device, an integrity of the test data during a period of testing and receiving of the test data; and
continuously verifying consistency of the identification data received from the tested participant device, by the verification server or the test results server;
recording, at the test results server, the test data result and associating with the test data result a validation of identification based on the identification data received simultaneously with the test data and a validation of integrity based on the step of continuously verifying the integrity of test data when receiving the test data.

2. The method of claim 1, wherein the verification server is a verifier device, the verifier device being a portable electronic device configured to communicate with the test results server, participant device.

3. The method of claim 1, wherein the identification data comprises a participant identifier, a test kit identifier, and accessory identifiers.

4. The method of claim 1, wherein the test data comprises results of testing for a specific pathogen by the pathogen testing system.

5. The method of claim 1, wherein the validation of integrity includes verifying the continuity and consistency of the identification data throughout the testing process.

6. The method of claim 5, wherein the continuous verification of the integrity of the test data comprises monitoring the testing process through image analysis using a camera of the participant device.

7. The method of claim 6, wherein the continuous verification of the integrity of the test data comprises ensuring compliance with predefined testing standards.

8. The method of claim 7, wherein the validation of identification is performed using facial recognition technology to confirm the identity of the participant.

9. The method of claim 8, wherein the test data result is recorded using distributed ledger technology to ensure data availability and verifiability.

10. A method for verifying innocuity of a tested participant associated to a tested participant device, the method to be executed by a system comprising the tested participant device and the verifier device, and a test results server, the method comprising:
receiving, by the verifier device, identification data from the tested participant device;
receiving, by the verifier device or by the test results server and then by the verifier device, test data simultaneously with the identification data to determine that the test data is consistent with the identification data of the tested participant device, further comprising continuously verifying at least one of:
an integrity of the test data during a period of testing and receiving of the test data and
consistency of the identification data received from the tested participant device;
continuously displaying a validation of integrity of the tested participant on a display of the verifier device on another device for visual display of test results based on the step of continuously verifying the integrity of test data at the verifier device when receiving the test data result.

11. The method of claim 10, further comprising continuously verifying both:
the integrity of the test data during the period of testing and receiving of the test data and
consistency of the identification data received from the tested participant device;

12. The method of claim 11, wherein the validation of integrity includes verifying the continuity and consistency of the identification data throughout the testing process.

13. The method of claim 11, further comprising providing an audible or haptic indication on the verifier device to confirm the validation of integrity of the tested participant.

14. The method of claim 12, further comprising opening a physical gate of access to a physical location to the tested participant.

15. The method of claim 12, wherein the continuous verification of the integrity of the test data includes monitoring the testing process through image analysis using a camera of the verifier device's camera.

16. The method of claim 14, wherein the continuous verification of the integrity of the test data includes ensuring compliance with predefined testing standards.

17. The method of claim 15, further comprising transmitting the test data result to the verifier device from the test results server via a telecommunication network.

18. The method of claim 10, further comprising providing a notification to the verifier device when a non-tested participant is detected within the vicinity of the tested participant.

19. The method of claim 10, wherein the identification data comprises a participant device identifier and accessory identifiers.

20. The method of claim 10, wherein the test data comprises results of testing for a specific pathogen.
